(19) United States
(12) Patent Application Publication
(10) Pub. No.: US 2007/0065596 A1
(43) Pub. Date: Mar. 22, 2007

(54) Plasma thin-film deposition method

(76) Inventors: Pavel Koulik, Blaesheim (FR); Svetlana Krapivina, Illkirch-Graffenstaden (FR); Nail Musin, Illkirch-Graffenstaden (FR); Anatoli Saitchenko, Illkirch-Graffenstaden (FR); Zorina Erquenia, Blaesheim (FR)

Correspondence Address: Clifford W. Browning;Krieg DeVault LLP, One Indiana Square, Suite 2800, Indianapolis, IN, 46204, US

(21) Appl. No.: 10/579,963

(22) PCT Filed: Nov. 19, 2004
(86) PCT No.: PCT/IB04/03795

§ 371 Date: May 19, 2006

(30) Foreign Application Priority Data
Nov. 20, 2003 (EP) 03026470.9
Feb. 2, 2004 (EP) 04002256.8

(51) Int. Cl. H05H 1/00

(52) U.S. Cl. 427/535

(57) ABSTRACT

A plasma thin-film deposition method for depositing a thin film on the surface of an object, wherein a plasma is generated in one or more inert plasmagenic gases and precursor gases, and the plasma is sprayed onto the surface being treated. The one or more precursor gases include at least two components, namely a first component including saturated organic substances and a second component including unsaturated organic substances, where the first component is a light radical source having a single free bond following a plasmochemical process carried out into the plasma zone, and the second component is a heavy radical source having two or more free bonds.

The present invention concerns a method for plasma depositing a thin-film on a surface to be treated. In particular, the invention relates to the depositing of organic or polymeric films, especially to achieve imperviousness of the surface to be treated.

Plasma methods for depositing a thin film on the surface of an object to be treated are already known and used in various areas, e.g. for depositing thin layers on semiconductors such as described in American patent U.S. Pat. No. 5,569,502, for depositing impervious layers or barriers on the surface of PET bottles such as described in international application PCT/IB02/01001, for depositing films on fabrics such as described in European patent EP 1 024 222, for depositing edible impervious films on foodstuffs such as described in WO 96/22030.

In many of these applications, it is sought to deposit very thin layers with a view to the advantages they provide, such as flexibility, transparency, the possible forming of multilayers, their non-impact on the general characteristics of the object to be treated, or for other properties.

For ingestible products, such as foodstuffs or pharmaceutical products, a very thin layer offers the advantage of being undetectable by the consumer.

In the area of textiles, very thin layers have the advantage of being highly flexible and able to maintain their integrity despite the major deformations undergone by objects made in fabrics, such as clothing. It is important however that this layer should be uniform to guarantee its imperviousness or other desired properties over the entire surface to be treated.

Plasma thin-film deposition methods often concern the depositing of inorganic films resulting from plasmochemical reactions of particles (ions, atoms, radicals, activated particles) derived from a precursor gas or mixture of precursor gases activated by a plasma. Most proposed methods are conducted in a partial vacuum to gain better control over plasma parameters and development conditions of the thin layer. Vacuum methods are extremely costly however for industrial applications and mass production. In addition, the presence of a vacuum has the disadvantage of affecting the properties of the object to the treated (e.g. dehydrating the objects to be treated). A further problem encountered when forming thin layers with known plasma methods is the creation of undesired powder on the treated surface.

Although inorganic films are desired in numerous applications, it will also be of advantage to be able to form thin films in organic or polymeric materials especially, but not only, in the area of ingestible products such as edible or pharmaceutical products. While some inorganic materials are permitted in small quantities in foods, and proposed by application WO 9622030 for example, there is a general desire to avoid their use as much as possible. The presence of elements in the human body such as debris of inorganic films containing different metals in oxide form may have harmful consequences. In addition, the method described in the above-cited application uses a vacuum plasma, a method that is costly and hardly suitable for mass production. Experience has also shown that the method of depositing inorganic films on the surfaces to be treated of foods, fabrics, paper or other items whose geometry and surface properties may vary quite extensively, is extremely difficult to control in reliable manner.

Regarding the area of foodstuffs, protective layers against oxidation (oxygen barrier) or against moisture loss or absorption (water and water vapour barrier) are highly sought after and various methods for depositing organic films, such as layers of cellulose, polydextrose, lipids or proteins have been put forward in the prior art. Known methods for depositing organic films on edible products do not use plasma however and give rise to layers whose thickness is insufficiently thin to go undetected or whose barrier properties are not very good or reliable.

Patent application WO 87/03453 for example proposes the use of organic deposits, such as cellulose and lipid layers to protect edible products. These layers are deposited in the form of a solution or liquid suspension and are then dried. Aside from the difficulty in depositing a very thin film forming a good barrier using this method, the drying process is costly and may have harmful effects on the object to be treated.

U.S. Pat. No. 6,312,740 proposes depositing a layer in the form of an electrostatically charged edible powder on the surface of foodstuffs, a corona discharge being used to charge the powder particles. It is mentioned that the ideal particle size is in the order of 120 μm, such sizes still being perceived however by the consumer.

It is to be pointed out that the efficacy of the deposited layers is determined by their thickness, their density and their adhesion to the surface to be treated. When depositing a film on edible products, the increase in the thickness of the layer leads to a change in the taste of the protected product.

Experience has shown that particles having a size of over 1 μm can be perceived. This means that the protective layer must be ultra-thin, if possible less than 0.5 μm. For foodstuffs, it is also sought to achieve layers which do not contain any toxic product, which do not affect the taste of the product and which, for most applications, are not water soluble.

No method proposed to date satisfactorily meets these requirements.

These thin layer properties are also sought for applications in other areas, e.g. for proofing fabrics or paper, depositing a film on bottles and packaging, in particular for foods or pharmaceuticals, or for other applications.

In the light of the above, one purpose of the invention is to provide a method for depositing a film on a surface to be treated, the film being very thin, uniform and effective, the method being adapted for industrial production, in particular for the treatment of objects that are mass produced.

It is of advantage that the method and device for implementing the method should not be costly.

It is of advantage to provide a method and device for implementing the method with which it is possible in reliable manner to deposit thin layers on objects of different shapes and sizes or having complex surfaces.

It is of advantage to provide a method for depositing a thin film that contains no or scarcely any inorganic components, in particular in the food and pharmaceutical sectors.

It is of advantage to provide a method for depositing a film on various foods or pharmaceutical products or other products that are ingested, which can be implemented on a production line at reasonable cost.

It is of advantage, for some applications, to provide a method for depositing a very thin layer, less than 1 μm in particular, in organic or polymeric matter on the surface to be treated of various materials.

Another purpose of the invention is to provide an impervious film for foods, pharmaceutical products or other ingestible products that is effective, reliable and harmless.

A further purpose of the invention is to provide organic or polymeric coatings that are very thin, uniform and effective, in particular coatings forming a barrier against liquids or gases.

Some purposes of the invention are attained using the method as in claim 1.

In the present invention, the film depositing process is based on the generation of a plasma in a mixture of inert plasmagenic gas and precursor gases and then spraying the resulting gas (plasma) onto the surface to be treated. The precursor gases contain at least two components.

A first component comprises saturated organic substances or a mixture of saturated organic substances.

A second component contains unsaturated organic substances or a mixture of unsaturated organic substances.

The composition of precursor gases includes carbon and/or hydrogen and/or halogenic elements.

The unsaturated organic substances are the main source of heavy, free, multivalent radicals. These chiefly form the building blocks of the polymeric chain.

The saturated organic substances, subsequent to plasmochemical processes in the plasma zone, come to be the main source of light, free radicals with a single free bond. These radicals are responsible for halting the development of the polymeric chain.

The heavy multivalent radicals are more adsorbed on the surface. This means that the ratios between the quantities of building blocks and single-bond radicals are different on the surface to be treated and within the volume. Firstly this gives rise to a shortened polymeric chain and hence to limited formation of powder within the volume, and secondly to intensified film depositing on the surface.

Film depositing is stimulated by prior activation of the surface.

Another major advantage of this method is that it can be conducted under atmospheric pressure and does not therefore require any pump or vacuum enclosure, thereby simplifying the equipment needed for implementing the method in an industrial environment, in particular for treating mass produced objects. The use of two precursor gases or mixtures of precursor gases according to the invention, also makes it possible to achieve a high film depositing rate, higher than depositing rates when using vacuum plasma methods.

The inventive method also has the advantage of positioning the electric discharge to create the plasma, at a relatively long distance away from the surface to be treated, which optimises the yield of the method and avoids the problem of overheating the object to be treated. The radicals derived from the at least two precursor gases or mixtures of precursor gases enter the plasma and live for a certain time, corresponding to the maximum migration time to bring the radicals to the surface to be treated for plasmochemical reaction therewith. This optimal distance is also determined by the need to activate the surface to be treated with ionised particles and ultraviolet radiation, and with the activated atoms formed by the plasma.

To obtain protective polymeric films on product surfaces, food products for example, it is advantageous to use as precursors the gases consisting of CₖHₗ, CₘFₙ or CₛHₚFᵣ or their mixtures. The formation of the protective film is determined by volume and surface plasmochemical processes.

The surface processes take place on the surface of the object to be treated, in several steps:

Formation of development centres on the surface to be treated, previously activated by the plasma. This surface may be smooth or rough, or even highly uneven since the activated medium acting on the surface under atmospheric pressure, especially out of thermodynamic equilibrium, may have very low viscosity determining penetration of the active components between the surface irregularities.

Genesis (initiation) of chains due to the depositing of active multivalent free radicals, derived from the heavy precursor gas or gas mixture, on the surface to be treated:

Development centre+M′→M₁′

Chain development:

M₁′+M′→M₂′

M₂′+M′→M₃′

M₃′+M′→M₄′ etc;

Rupture of the chain by monovalent radicals derived from the light precursor gas or gas mixture

Mₙ′→Pₙ, where Pₙ, is a non-active polymer.

In this way it can be seen that the formation of the polymeric layer on the surface of the product to be treated comprises the formation of “building blocks” in the plasma zone, the migration of these blocks towards the surface, and the formation of a polymeric layer not containing free radicals on the surface.

Evidently the formation of polymeric powders within the volume and the formation of the polymeric layer on the surface compete with one another. This competition is solved in particular through the choice of components for the mixture of precursor organic gases.

For example, advantageously a mixture of an unsaturated component is used such as hexafluoropropylene (C₃F₆) and a saturated component such as tetrafluoromethane (CF₄).

The CF₄, when entering the plasma, in particular forms light radicals CF₃′. It is these radicals which halt the formation of the polymeric chains.

The C₃F₆ forms the heavy biradicals (CF₃-CF-CF₂)″ which are the polymer building blocks.

In principle, these reactions take place within the volume and on the treated surface. The competition between the volume and surface formation of polymers is determined by the ratio between the concentrations of heavy and light radicals. On the surface the concentration of heavy biradicals prevails over that of light radicals, which promotes the formation of the polymeric film on the treated surface.

In the volume, the concentration of CF₃′ light radicals prevails over that of heavy radicals. This slows down the formation of polymeric powders therein.

By varying the proportions of these components empirically, the experiments conducted under the invention show that it is possible to practically exclude the formation of powder in the volume.

The use of fluoro-organic precursors, such as in the above-cited example, allows the formation of a film of polytetrafluoroethylene (—CF₂-CF₂—)ₙ on the surface to be treated.

The polytetrafluoroethylene film (also commonly known as “Teflon”) is a film having very good moisture and oxygen barrier properties, and is a harmless material and hence well suitable for uses in the area of edible products, whether for depositing a film on food products or on wrapping for the packaging of food products or drinks.

Other halogen-organic precursors may also be used for the formation of polymeric layers on a surface to be treated. However since the presence of chlorine in ingestible products in generally not desirable, polymeric layers containing chlorine are to be used in non-food areas.

Under the invention, it is also possible to use hydrocarbons as precursor gas with which to form polymeric films on the surface to be treated, in particular branched polyethylene (—CH₂-CH₂—)ₙ.

If the precursor product is a mixture containing carbon, fluorine (or another halogen) and hydrogen, a co-polymerisation reaction is obtained.

One important advantage of the inventive method is the possibility of properly controlling the formation of polymeric layers on the surface of the object to be treated, avoiding volume growth, hence obtaining layers of highly uniform thickness. The high uniformity of the deposited layers implies that very thin layers, even monomolecular i.e. in the order of 0.5 nanometres, are well distributed on the surface to be treated. Since the development of the layer on the surface to be treated takes place on the surface and not within the volume, layers of greater thickness can also be deposited with extensive uniformity, the thickness of the layers possibly being controlled for example by varying the treatment time. Under the invention, it is also possible to form a multilayer film, i.e. formed of layers of different compositions by injecting different precursor gases in sequence during plasma treatment. The mechanism allowing the development of polymeric layers on the surface also has the advantage of eliminating free radicals, which permits the use of the method for edible products. To conclude, the polymeric films formed by the method of the invention are chemically stable, biocompatible, impervious to gases and water, have high elasticity and mechanical solidity and have good dielectric qualities. Their thickness can vary depending upon the constraints of the application between 0.5 nm (monomolecular layer) and 0.5 μm, a thickness above which the deposited film may disintegrate and separate from the treated surface.

The generated plasma, depending upon application, is continuous or pulsed. It is supplied by a direct, alternating or high frequency current source, or microwave. The generated plasma is especially effective under pulsed operation.

The method may advantageously be implemented using a plasma under atmospheric pressure allowing relatively easy integration of the treatment device in an industrial production line and to perform film depositing at industrial production rates.

With the inventive method, a plasma is preferably generated that is not in thermodynamic equilibrium, this plasma lending itself to the efficient formation of layers, even very fine layers, on the surface to be treated at atmospheric pressure. Advantageously it is possible to control the discharge pulses in order to generate shock waves which generate ultrasonic vibrations improving the plasmochemical reactions and destroying the hydrodynamic boundary layer on the surface to be treated. All these elements contribute towards accelerating the film depositing process and increasing its efficacy.

The precursor gases, carrying the elements forming the film, are introduced into the film depositing zone either simultaneously in particular in the form of a mixture, or consecutively in the form of portions of different gas mixtures.

In the former case, the optimal composition of the quantities of the different precursor gases can be achieved empirically.

In the latter case, it is possible, whilst maintaining the opportunity of depositing films of optimal composition containing no or only little powder, to form multilayer films which not only ensure the imperviousness of the film but also its flexibility, solidity and other properties (mechanical, optical, chemical). In this case, the composition of the resulting film varies over its thickness. In particular the film may be considered to be multilayer.

The parameters of the film depositing process, in particular the plasma generation parameters and activation of the surface to be treated, may be adapted so as to kill the microorganisms present on the treated surface at the time of treatment. This property of the present invention is particularly useful when treating food products. During such treatment, these products are not only coated with a protective film preventing the migration of gases (oxygen in particular), vapours (water vapours in particular) and water in liquid phase, but also the migration of microorganisms such as mould or yeast brought by the ambient atmosphere or outside contact.

Devices for implementing the method and examples of treatment are described below with reference to the drawings in which:

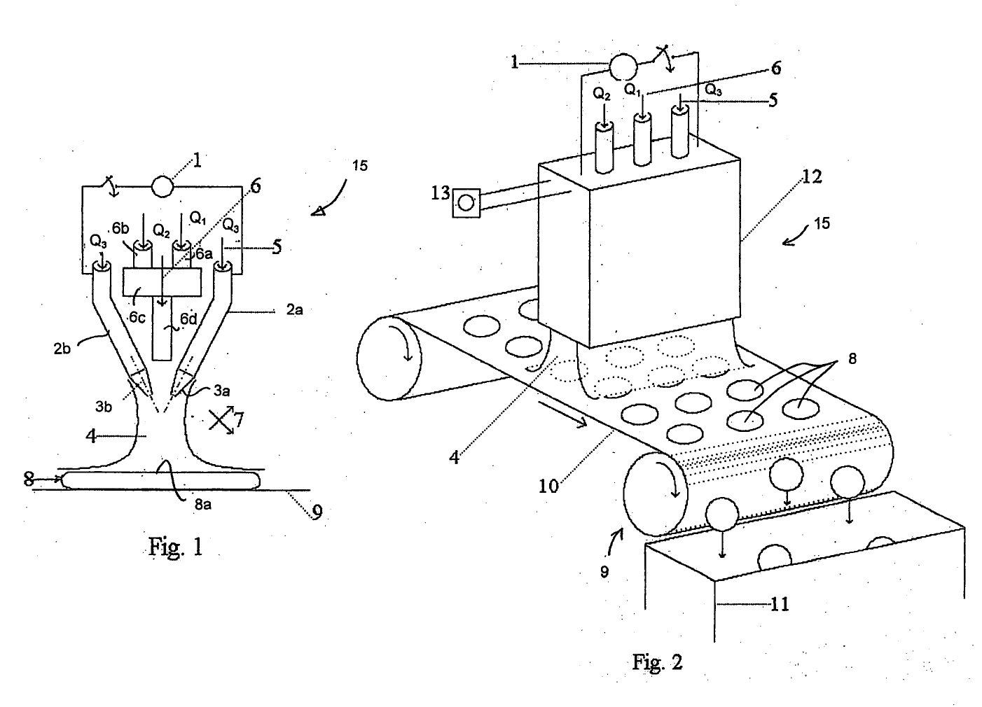

FIG. 1 is a simplified schematic illustrating a plasma device with two nozzles for local treatment by two-dimensional scanning of the surface to be treated;

FIG. 2 is a simplified schematic illustrating a plasma device of the invention, intended to be inserted in an industrial production line;

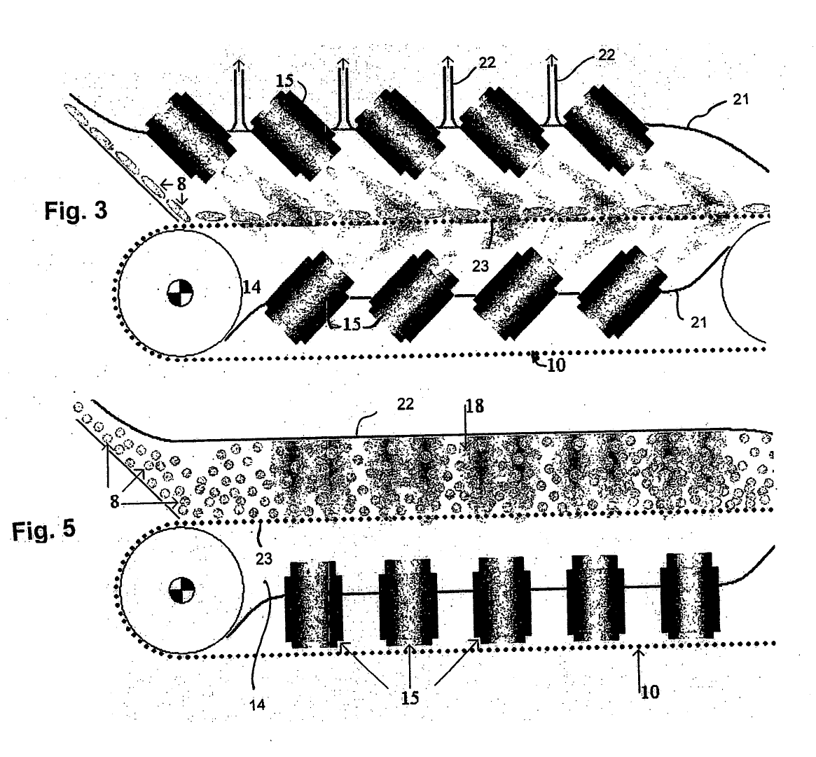

FIG. 3 is a simplified schematic, illustrating another variant of a plasma device to be inserted in an industrial production line;

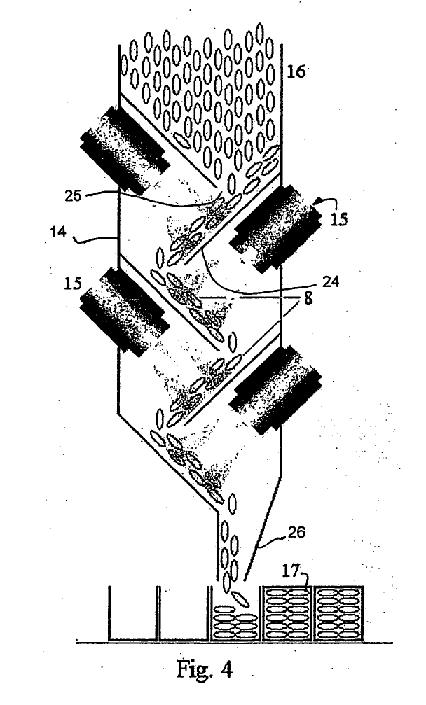

FIG. 4 is a simplified schematic, illustrating another variant of a plasma device to be inserted in an industrial production line;

FIG. 5 is a simplified schematic, illustrating another variant of a plasma device to be inserted in an industrial production line;

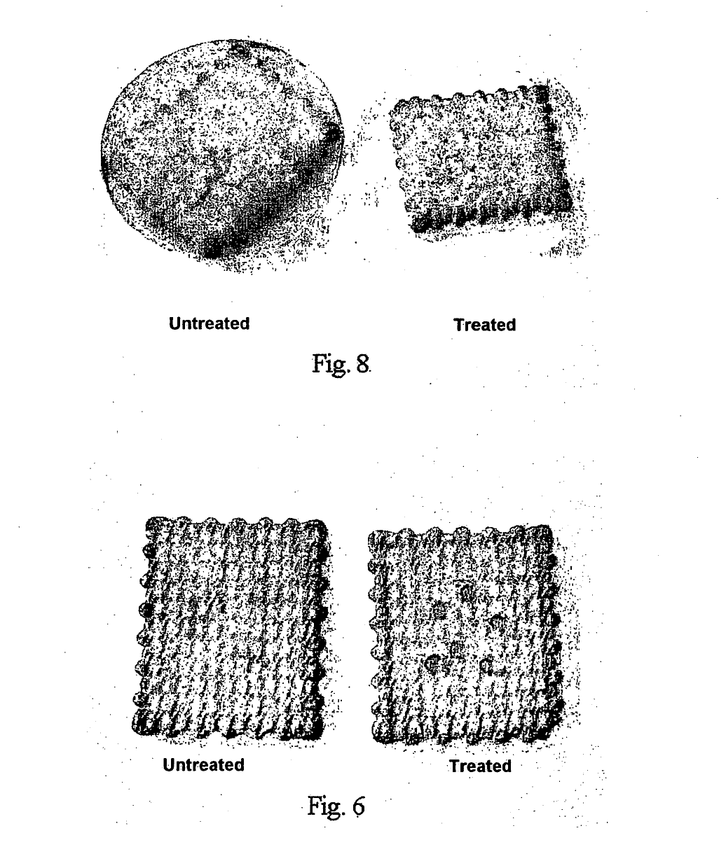

FIGS. 6 to 11 are photographs of untreated and treated food products, illustrating the water imperviousness of the products treated with the plasma methods of the invention, compared with untreated products;

FIG. 6 shows drops of coloured water on biscuits;

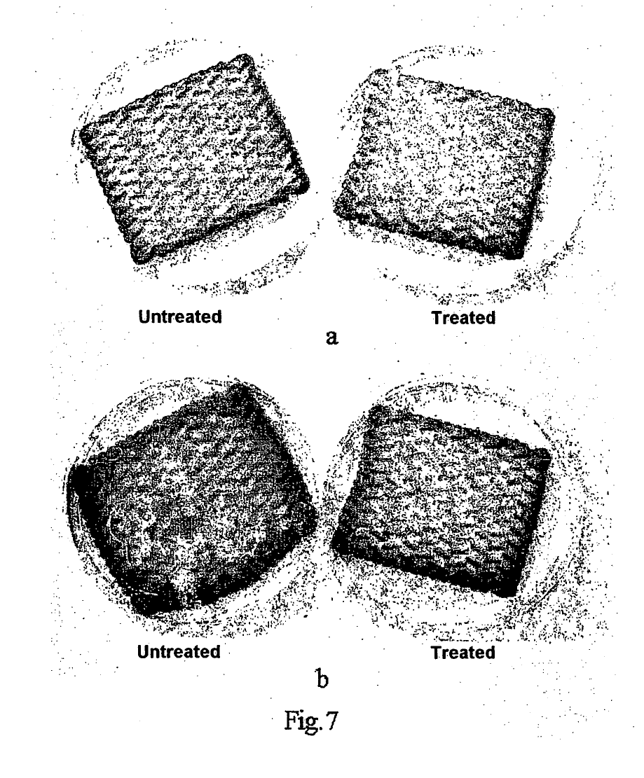

FIG. 7 shows biscuits in water, FIG. 7a being a photo taken immediately after immersion, and FIG. 7b being a photo taken 20 sec after immersion;

FIG. 8 shows biscuits in water, the photo being taken 30 min after immersion;

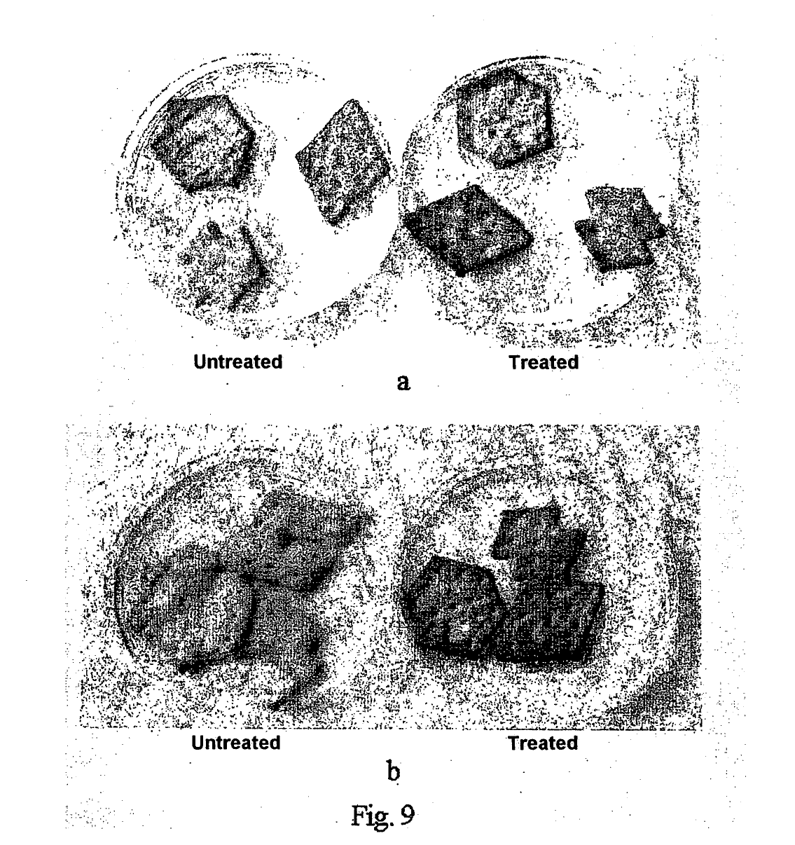

FIG. 9 shows crackers in water, FIG. 9a being a photo taken immediately after immersion, and FIG. 9b being a photo taken 20 sec after immersion;

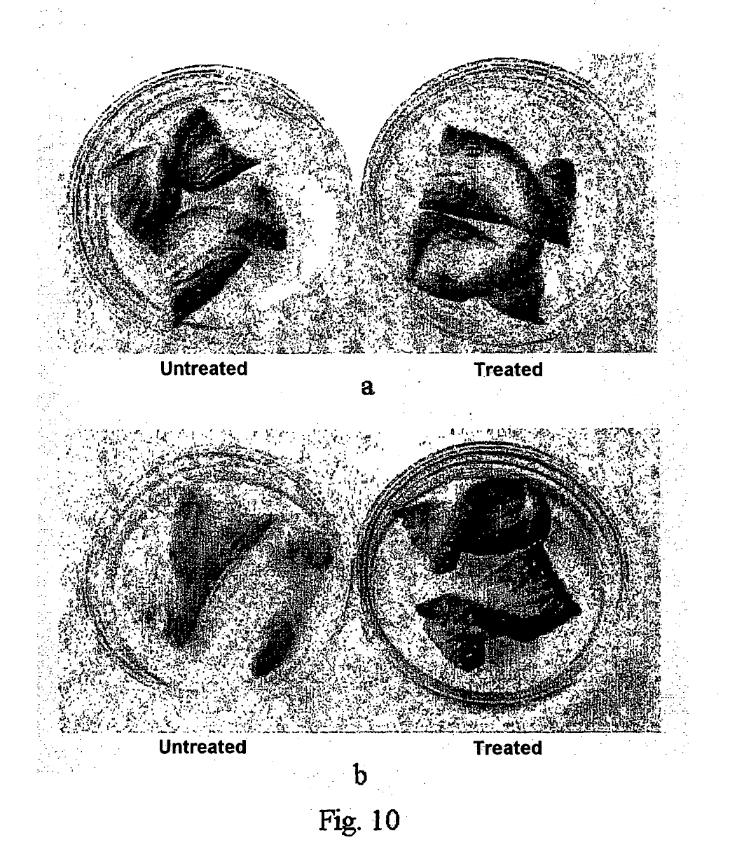

FIG. 10 shows flaky butter snacks in water, FIG. 10a being a photo taken immediately after immersion, and FIG. 10b being a photo taken 40 min after immersion; and

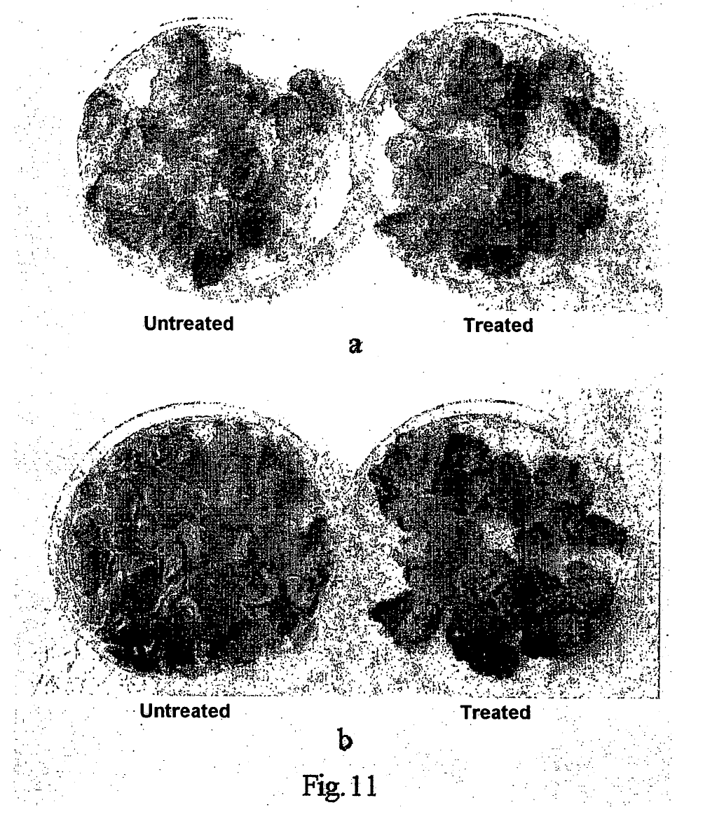

FIG. 11 shows corn flakes in water, FIG. 11a being a photo taken immediately after immersion, and FIG. 11b being a photo taken 1 h after immersion.

With reference to FIGS. 1 to 5, a device for plasma surface treatment to implement a method of the invention comprises one or more plasma generators 15, producing a plasma 4 applied to the surface to be treated 8 that is mobile relative to the plasma generator, either by means of a kinematical system 9 such as a conveyor 10 (FIGS. 2, 3 and 5) or moving under gravity through a reactor 14 (FIG. 4) subjected to vibrations for example to ensure the controlled flow of the objects to be treated through the reactor.

Referring particularly to FIGS. 1 and 2, the plasma generator 15 comprises a current source 1, e.g. an alternate 50 Hz current source with a nominal voltage of 1000 V, connected to electrodes 2a, 2b in the form of tubes for example supplied at one end by a plasma formation gas Q₃ and at the other end having nozzles 3a, 3b to direct and influence the form of the generated plasma 4. The plasma generator 15 also comprises a supply system 6 supplying precursor gases Q₁, Q₂, this system comprising inlet ducts 6a, 6b, a mixer 6c and an outlet duct 6d. The precursor gas supply system may also be a separate device from the plasma generator, but it is advantageous to integrate this device in the generator or block of generators so as to better control the passing of precursor gases into the plasma and the resulting components on the surface to be treated 8a.

The outlet duct 6d for the precursor gases and the nozzles 3a, 3b for the plasma formation gas are used to direct and control the geometric shape of the flow of plasma 4 on the carrier 9 conveying the objects to be treated.

The carrier 9 and/or generator 12 may be mounted on a kinematical system performing a relative movement in one or more directions, so that the flow of plasma 4 scans the objects to be treated. The kinematical system may be a conveyor in an industrial production line, such as shown FIG. 2 and FIGS. 3 and 5 in which the objects to be treated 8 pass through the plasma 4 sprayed towards the conveyor surface.

In the device shown FIG. 2, in order to form a linear curtain of plasma 4 essentially having the width of the conveyor on which the objects to be treated are positioned, several plasma generators may be mounted side by side in a block of generators 12. The block of generators has ducts to feed the plasma formation and precursor gases, a current source and a microprocessor controller 13 coupled to the current source in order to control the electric energy supply parameters of the plasma generators.

With reference to FIG. 3, it is also possible to arrange plasma generators in the form of plasmotrons along the conveyor either side of the belt 23 of the conveyor, the plasma being enclosed in an enclosure of a reactor delimited by walls 21 and comprising ventilation ducts 22 for residual gases. In this case, the belt 23 of the conveyor may be in the form of a grid or metal mesh to allow treatment by the plasma generated either side of the belt 23 over the entire periphery of the object to be treated. For the surface treatment of objects that are relatively small or light, such as shown FIG. 5, the plasma generators 15 may be arranged underneath the objects to be treated, the hydrodynamic forces of the plasma jets being used to lift and stir the objects to be treated thereby ensuring plasma surface treatment over the entire surface of the object.

The stirring and turning of the objects carried on a conveyor may also be achieved by causing the conveyor belt to vibrate and, in this case, it is possible only to provide plasma generators on the upper side of the belt.

Instead of using a kinematical system to move the objects to be treated, it is also possible to cause them to move through the plasma flows in the enclosure of a reactor 14 under gravity or hydrodynamic force (blown air for example). The reactor 14 may be provided with guiding elements, e.g. in the form of walls 24 to direct the objects to be treated 8 successively into the plasma flows sprayed by the plasma generators 15. The enclosure of reactor 14 is preferably vibrated to ensure the flow of objects to be treated through the orifices 25 formed by the guiding elements which also control the flow of objects to be treated through enclosure 14. Evacuation of the products to be treated can be directed towards a packaging system 17 mounted on a kinematical system.

The plasma generators are preferably placed in the enclosure of a reactor consisting of a casing to insulate the plasma hydrodynamically from the outside environment, so as to better control the plasma flows on the objects to be treated.

The plasma generator may be a direct current, alternate current, high frequency or microwave generator. Preferably, the generator is designed to supply the discharge with electric pulses. In this case, it preferably comprises a chopper device in a microprocessor 13 with which to form pulses in amplitude and duration as per the constraints of the method.

Examples of the surface treatment of objects, in particular edible products, using methods of the invention are described below.

### EXAMPLE 1

The food product to be treated is a sweet biscuit, commonly known under the name “Petit Beurre”. The product was placed in the reactor of a device corresponding to FIG. 1. Treatment was conducted under atmospheric pressure.

The parameters were as follows:
1. Plasmagenic gas: argon
2. Precursor gas: tetrafluoromethane (50%) and hexafluoropropylene (50%)
3. The discharge supply is made via a high voltage alternate current source. The plasmotron is a plasma generator consisting of two electrodes in the form of nozzles through which the gases arrive in the plasma zone.
4. Start-up voltage of discharge: 10 kV
5. Voltage during discharge: 1÷25 kV
6. Current: 100 mA
7. The plasmagenic gas and precursor gases are sprayed into the discharge zone by the electrode nozzles.
8. The total gas flow rate is ≦5 l/min
9. The distance between the electrodes and the treated surface is ˜4 cm.
10. The linear speed of the treated surface with respect to the plasma is ˜1 m/min
11. The scanning speed is 10 cm/min
12. The treatment time is: 30 sec
   Results

The composition of the deposited film, which is verified by infrared spectroscopy, is tetrafluoroethylene (teflon), the mean thickness of the layer being 30 nm.

Using the paramagnetic electronic spectroscopy method, it was found that there is no trace of residual free radicals on the treated surface.

The treated biscuits were tested for imperviousness to water. The drops of water deposited on the surface of the untreated biscuit are immediately absorbed. The drops of water deposited on the surface of the treated biscuit are not absorbed. They roll over the surface without being absorbed such as shown FIG. 6.

The treated and untreated biscuits were immersed in water. The untreated biscuit immediately absorbed water such as shown FIG. 7. The treated biscuit only started to absorb water slowly after 30 min, such as shown FIG. 8.

The increase in weight of the biscuits immersed in water for 5 sec was:

| | |
|---|---|
| Untreated: | 88%; |
| Treated: | 0.7% |

### EXAMPLE 2

The product to be treated was “Flaky butter snacks” such as shown FIG. 10.

They were treated using a device such as shown FIG. 1.

The parameters used were those of example 1.

Precursor gas: methane 60%, acetylene 40%.

Results

The thickness of the film obtained was 100 nm. The film obtained consisted of polyethylene. The tests for water imperviousness showed that the untreated product absorbs water in 1 minute. The treated product only absorbed water 40 min after its immersion, such as shown FIG. 10.

The increase in weight of the untreated and treated products immersed in water for 30 sec, was:

| | |
|---|---|
| Untreated: | 91%; |
| Treated: | 0.8% |

### EXAMPLE 3

The treated product was “Corn Flakes” such as shown FIG. 11. The device used for plasma treatment was of the type corresponding to FIG. 4.

The treatment parameters were:
1. Plasma formation gas: argon
2. Precursor gases: tetrafluoromethane 70%+tetrafluorethylene 30%
3. The plasma generator was a generator with high frequency current (f=13.56 MHz)
4. Power of the plasma generator: 20 kW
5. Treatment time: 30 sec
   Results

The treated “Corn Flakes” were coated with a film of Teflon 30 to 40 nm thick. After 5 min the untreated “Corn Flakes” immersed in water lost their shape and properties such as shown FIG. 11a.

The treated “Corn Flakes” had not lost their shape and properties 1 hour after immersion in water, as shown FIG. 11b.

### EXAMPLE 4

The treated product was a cereal product of mean diameter 5 mm. Treatment was conducted using a device of the type shown FIG. 5 with “boiling layer”.

The plasma formation gas (Ar) was sent onto the conveyor screen mixed with a precursor gas (mixture of methane 60% and hexafluoropropylene 40%) creating a “boiling layer” making it possible to properly mix the reactive gas with the product.

Treatment lasted 45 sec.

The treated and untreated products were subjected to water absorption tests. The untreated products lost their properties 5 min after their immersion. The treated products did not lose theirs for one hour after immersion in water.

### EXAMPLE 5

The treated product was a medicinal product, Cimetrol 500 LPCI (Metronidazole) in the form of 500 mg tablets. These tablets are highly sensitive to humidity.

Treatment was conducted using a device of the type shown FIG. 5 with a “boiling layer”.

Conditions were identical to those for example 4.

Treatment lasted 20 sec.

The treated tablets were subjected to water absorption tests. The untreated tablets absorbed water in 2 min. The treated tablets remained intact 10 hours after immersion.

With the treatment it is possible to increase the shelf life of this medicinal product packed in blisters from two months to over two years.

### EXAMPLE 6

The treated product was sulfite paper (resin glue 0.5%; alumina 0.5%; cooling filler 25%) The sample (150×150 mm) was placed in the reactor of a device corresponding to FIG. 1.

The parameters used were those of example 1.
Plasmagenic gas: argon
Precursor gases: mixture methane (50%) and hexafluoropropylene (50%).
   Results

The resistance of the paper was estimated using the stability of its mechanical characteristics during thermal ageing (T=100±3° C.) for 30 days and exposure of both sides to ultraviolet rays under a UV lamp for 60 min.

Tests showed that the solidity and deformation characteristics of the samples remained practically unchanged.

Impregnation through capillarity dropped from 36 mm/10 min for the untreated samples, to 0 for the treated samples. The wettability contact angle of the treated samples was 125 degrees.

### EXAMPLE 7

The treated product was a fabric (density-540 g/m²). The sample (150×150 mm) was placed in the reactor of a device corresponding to FIG. 1.

The parameters used were those of example 1.
Plasmagenic gas: argon
Precursor gases: mixture of tetrafluoromethane (75%) and hexafluoropropylene (25%).
   Results

The oil repelling measurement on the treated sample was 120.

The drops of water deposited on the surface dried without impregnating the fabric.

Resistance to a column of water after treatment increased from 0 to 190 cm.

In other words, the treated sample was highly hydro and oleophobic.

The hydrophobic and oleophobic properties were not deteriorated after boiling the samples for 1 hour in standard soapy water.

1-11. (canceled)

12. Method of thin film deposition by plasma, on the surface of an object to be treated, comprising the generation of plasma at atmospheric pressure in one or more inert plasmagenic gases and precursor gases, and projection of said plasma onto the surface to be treated, the precursor gas or gases comprising at least two components, a first of said components containing saturated organic substances and a second of said components containing unsaturated organic substances, the first component being a source of light radicals with a single free bond subsequent to a plasma chemical process In the plasma zone, and the second component being a source of heavy radicals with two or more free bonds, the rate of flow of precursor gases being controlled to optimize the speed of film deposition and the gas and liquid barrier strength of the film.

13. Method of claim 12, wherein the precursor gases contain carbon, hydrogen and halogens.

14. Method of claim 13, wherein the halogen is fluorine and a layer of Teflon is deposited.

15. Method of claim 12, wherein the precursor gases contain carbon and hydrogen.

16. Method of claim 15, wherein a layer of polyethylene is deposited.

17. Method of claim 12, wherein the object to be treated is an edible product.

18. Method of claim 12, wherein the plasma is generated by pulses of electric current, the growth front and the duration of pulses being controlled in order to generate discharges that are not in thermodynamic equilibrium.

19. Method of claim 12, wherein the plasma is sequentially supplied with different precursor gases in order to deposit a multilayer film, of variable composition over its thickness.

20. Device for implementing the method of claim 12, comprising plasma generators comprising electrodes adapted to create an electric discharge supplied by a current source, and a system adapted to supply at least two precursor gases, each of said generators being arranged in the enclosure of a reactor (14), the device also comprising a kinematical system to convey objects to be treated through the plasma flow generated by the generators, the device operating under atmospheric pressure, wherein the kinematical system conveying the objects to be treated comprises a conveyor belt (23) in the form of a grid or mesh to allow surface treatment over the entire periphery of the object to be treated.

21. Device for implementing the method of claim 12, comprising plasma generators comprising electrodes adapted to create an electric discharge supplied by a current source, and a system adapted to supply at least two precursor gases, the generator being arranged in the enclosure of a reactor (14), the device also comprising a kinematical system to convey objects to be treated through the plasma flow generated by the generators, the device operating at atmospheric pressure, characterized in that the device comprises guiding elements (24) to guide the flow of objects to be treated through the plasma flows of the plasma generators arranged along the reactor, the conveying of the objects to be treated being made under gravity or hydrodynamic flow.

22. Device as in claim 21, adapted to plasma treat a surface of objects of small size accumulated in a container of said device through which, from bottom to top, the plasma-derived gases flow so as to form a boiling layer ensuring treatment of the entire surface of each of the objects.
